(19) United States
(12) Patent Application Publication
(10) Pub. No.: US 2011/0165443 A1
(43) Pub. Date: Jul. 7, 2011

(54) METHOD FOR CONTROLLING A THERMOREGULATION DEVICE FOR A POWER SUPPLY BATTERY OF AN ELECTRIC TRACTION VEHICLE

(75) Inventors: David Zamparutti, Courbevoie (FR); Franck Ragot, Paris (FR); Muriel Ayrault, Colombes (FR); Thierry Hecketsweiler, Paris (FR)

(73) Assignee: Peugeot Citroen Automobiles SA

(21) Appl. No.: 13/063,071

(22) PCT Filed: Sep. 10, 2009
(86) PCT No.: PCT/FR09/51707

§ 371 Date: Mar. 9, 2011

(30) Foreign Application Priority Data
Sep. 11, 2008 (FR) 0856119

(51) Int. Cl. H01M 10/50

(52) U.S. Cl. 429/50

(57) ABSTRACT

The present invention related to a method for controlling a thermoregulation device for an electric vehicle power supply that is cooled by a coolant caused to flow by means for applying a flow rate of said fluid controlled by said thermoregulation device, said method comprising a step of predetermining a noise level prevalent in the passenger compartment of the vehicle, said noise level being predetermined on the bases of at least one of the following variables: engine load, engine speed, air conditioning pulser speed, or vehicle speed; and a second step of predetermining said flow rate of said coolant to be applied on the basis of the power supply battery temperature, the temperature of said coolant at the input of said battery, and said noise level predetermined during said first step. The invention can be used immediately in the automotive field.

### CROSS-REFERENCE TO RELATED APPLICATIONS

This application is a National Stage of International Application No. PCT/FR2009/051707, filed Sep. 10, 2009, which claims priority to French Application 08561119, filed Sep. 11, 2008.

### FIELD

The present invention relates to a method for controlling a thermoregulation device for a power supply battery of an electric traction vehicle.

More specifically, the invention relates to a method for controlling a thermoregulation device for a power supply battery of a vehicle which is driven by at least one electric motor.

### BACKGROUND

Known electric vehicles and/or hybrid vehicles have at least one electrical traction source including, a battery capable of going through charging/discharging cycles and an electric motor that uses the electrical energy of the battery to supply traction energy to the vehicle.

When the battery is in use and more specifically during charging/discharging cycles, the battery produces heat, specifically due to its internal resistance. Moreover, the performance of this type of battery depends heavily on its operating temperature.

Indeed, high operating temperature causes, on the one hand, accelerated aging and significant auto discharge, and on the other hand, for even higher temperatures, the interdiction of battery operation in order to avoid irreversible degradation.

When the ambient temperature is higher than the battery temperature, the ambient air flow cannot be used as a cooling source for evacuation of the heat produced by the accumulator elements of the battery.

For this reason, the power supply battery of an electric motor requires the use of a supplementary thermoregulation device to ensure cooling of the battery.

For this purpose, a heat transfer fluid flows through the cooling circuit of the battery in order to create heat transfer between the battery and the heat transfer fluid to reduce the temperature of the battery.

In known manner, a method for controlling the cooling or thermoregulation of a power supply battery consists of controlling the cooling device as a function of the battery temperature and the temperature of the heat transfer fluid. However, the devices delivering the heat transfer fluid, such as for instance a pump or a ventilator, have a certain impact on the acoustical or vibrational comfort experienced by the passengers in the cabin, especially since the cooling device in general is situated in the cabin of the vehicle. In fact, the higher the flow rate of the supplied heat transfer fluid, the higher the noise and parasitic vibrations emanating from the equipment delivering the flow. This acoustic nuisance is especially important when the vehicle is idling or driving at low speed. In these situations the noise level of the cabin is significantly reduced, since there is no or very little driving noise, or noise produced by the combustion engine, or aerodynamic noise.

In this context, the goal of the invention is to provide a method for controlling a thermoregulation device for a power supply battery of a vehicle with electrical traction ensuring efficient cooling of the power supply battery while protecting the passengers against acoustic hinder.

### SUMMARY

To this end, the invention is proposing a method for controlling a thermoregulation device for a power supply battery of a vehicle with electrical traction, cooled by means of a heat transfer fluid, which is circulated by means for providing a circulatory flow of said heat transfer fluid, and controlled by said thermoregulation device, in which said control method comprises:
a first stage for establishing the ambient noise level in the cabin of the vehicle, said noise level is determined in function of at least one of the following variables:
   engine load,
   engine speed,
   speed of the air conditioning blower,
   vehicle speed;
a second stage for establishing said circulatory flow rate of said heat transfer fluid to be applied in function of the temperature of the power supply battery, the temperature of said heat transfer fluid entering said battery and said noise level established during said first stage.

According to another characteristic, the control method is such that said first stage comprises:
a first stage for detecting a first noise level in function of said engine load and said engine speed;
a second stage for detecting a second noise level in function of said speed of the air conditioning blower;
a third stage for detecting a third noise level in function of said speed of the vehicle. Said noise level is determined by the maximum value of said noise levels.

According to another characteristic, the control method is such that it comprises a stage of continuous acquisition of the temperature of the heat transfer fluid entering the power supply battery, the battery temperature, the intensity of the current passing through the battery, the vehicle speed, the engine speed, the speed of the air conditioning blower, and the load of the engine.

According to another characteristic, the control method is such that it comprises a stage for establishing the flow rate of the heat transfer fluid determined as a function of said current intensity passing through said battery, said temperature of said battery, and said temperature of the heat transfer fluid entering the power supply battery.

According to another characteristic, the control method comprises a stage for establishing the flow rate of the heat transfer fluid determined in function of the thermal energy flow passing through said battery and the thermal energy flow evacuated by said battery by means of said heat transfer fluid.

According to another characteristic, the control method is such that it comprise a stage for establishing the flow rate of the heat transfer fluid for cooling of the power supply battery when the powertrain of the vehicle is turned off, said stage comprises:
a first step of evaluating the cooling requirements of said battery with determination of a first flow rate of the heat transfer fluid as a function of the intensity of the current passing through said battery and the battery temperature at the time that the powertrain is turned off;
a second step of regulating said first flow rate of the heat transfer fluid and for establishing a second flow rate as a function of the temperature gradient between said temperature of said battery at the time the powertrain is turned off and said battery temperature;
a third step of coordinating the different data of said first step and said second step for determining said flow rate of the heat transfer fluid for cooling of the battery.

According to another characteristic, the control method is such that it comprises a reheating stage of said power supply battery by determining the flow rate of the heat transfer fluid as a function of said temperature of said battery and of the temperature of said heat transfer fluid entering the battery during a reheating stage of the power supply battery.

According to another characteristic, the control method is such that an increase of the noise level inside the cabin of the vehicle entails an increase of said maximum circulation flow rate.

The present invention also has a goal a thermoregulation device comprising means for implementing a control method.

Further areas of applicability of the present teachings will become apparent from the description provided herein. It should be understood that the description and specific examples are intended for purposes of illustration only and are not intended to limit the scope of the present teachings.

### DRAWINGS

FIG. 1 is a functional diagram of a method for controlling a thermoregulation device for a power supply battery of a vehicle with electrical traction according to the invention.

FIG. 2 is a functional diagram illustrating a first stage of the method for controlling a thermoregulation device for a power supply battery of a vehicle with electrical traction according to the invention.

FIG. 3 is a functional diagram illustrating a second stage of the method for controlling a thermoregulation device for a power supply battery of a vehicle with electrical traction according to the invention.

FIG. 4 is a functional diagram illustrating a third stage of the method for controlling a thermoregulation device for a power supply battery of a vehicle with electrical traction according to the invention.

FIG. 5 is a functional diagram illustrating a fourth stage of the method for controlling a thermoregulation device for a power supply battery of a vehicle with electrical traction according to the invention.

FIG. 6 is a functional diagram illustrating a fifth stage of the method for controlling a thermoregulation device for a power supply battery of a vehicle with electrical traction according to the invention.

FIG. 7a illustrates in the form of a graph an example of the distribution of a first noise level established by the control method as a function of the load and the speed of the combustion engine.

FIGS. 7b, 7c, and 7d are figures illustrating in the form of a graph examples of the distribution of the flow of a heat transfer fluid.

In all figures, common elements carry the same reference unless otherwise indicated.

### DETAILED DESCRIPTION

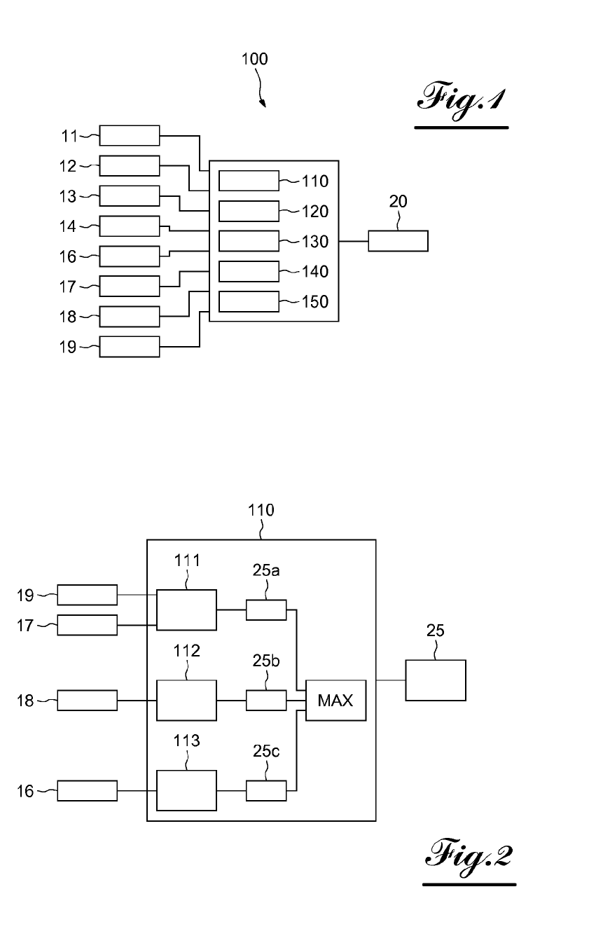

FIG. 1 provides a functional diagram of a method 100 for controlling a thermoregulation device for a power supply battery of a vehicle with electrical traction according to the invention.

The control method 100 controls the cooling of a battery supplying power to an electric motor utilizing a thermoregulation device (not shown) in association with:
a cooling circuit adjacent to at least one wall of the power supply battery or integrated in the battery;
a heat transfer fluid circulating through the cooling circuit; and
a pumping or ventilating apparatus capable of generating a flow rate of the heat transfer fluid in the cooling circuit.

The control method 100, illustrated according to the functional diagram of FIG. 1, uses various information such as:
the temperature 11 of the heat transfer fluid entering the power supply battery,
the temperature 12 of the heat transfer fluid exiting the power supply battery,
the temperature 13 of the battery,
the intensity of the current 14 passing through the battery,
the speed of the vehicle 16,
the speed of the combustion engine 17,
the speed of the air conditioning blower 18, and the load of the combustion engine 19.

This information is used as input data for determining, by way of a control strategy, a flow rate 20 of the heat transfer fluid.

The control method 100 comprises a plurality of steps 110, 120, 130, 140, 150 detailed in FIGS. 1 to 6, and consists of determining a plurality of optimized calorific flow rates, wherein each of the flow rates corresponds optimally with an actual condition of the battery. Via the plurality of steps 110, 120, 130, 140 and 150, the control method 100 selects a final calorific flow rate 20 to be applied by the thermoregulation device for cooling of the power supply battery by selecting the maximum flow rate among said plurality of flow rates.

Additionally, the control method 100 supplies a calorific flow rate 20 suitable for cooling the power supply battery by taking into account the environmental constraints, such as the noise level within the cabin of the vehicle.

In this way, the control method 100 can limit under certain conditions the calorific flow rate while anticipating the cooling of the battery when the battery is highly stressed and by adapting the cooling needs of the battery when the vehicle is stopped in order to limit noise and electrical consumption.

FIG. 2 provides a functional diagram illustrating a first step 110 of the method 100 for controlling the thermoregulation device for the power supply battery of the vehicle with electrical traction according to the invention.

During this first step 110, the control method 100 determines the noise level 25 present in the cabin of the vehicle.

The noise level 25 corresponds with a maximum noise level originating from three characteristic noise generating sources in a running vehicle. Among these three sources are a first intermediate noise level 25a comprising the noise coming from the combustion engine, a second intermediate noise level 25b comprising the noise of the air conditioning blower, and a third intermediate noise level 25c comprising the driving or road noise. These three sources of noise are treated independently by the control method 100.

The first intermediate noise level 25a is established by way of input data such as the speed of combustion engine 17 and the load 19 of the combustion engine.

The second intermediate noise level 25b is established by way of the speed of the air conditioning blower 18.

Finally the third intermediate noise level 25c is established by way of the speed of vehicle 16.

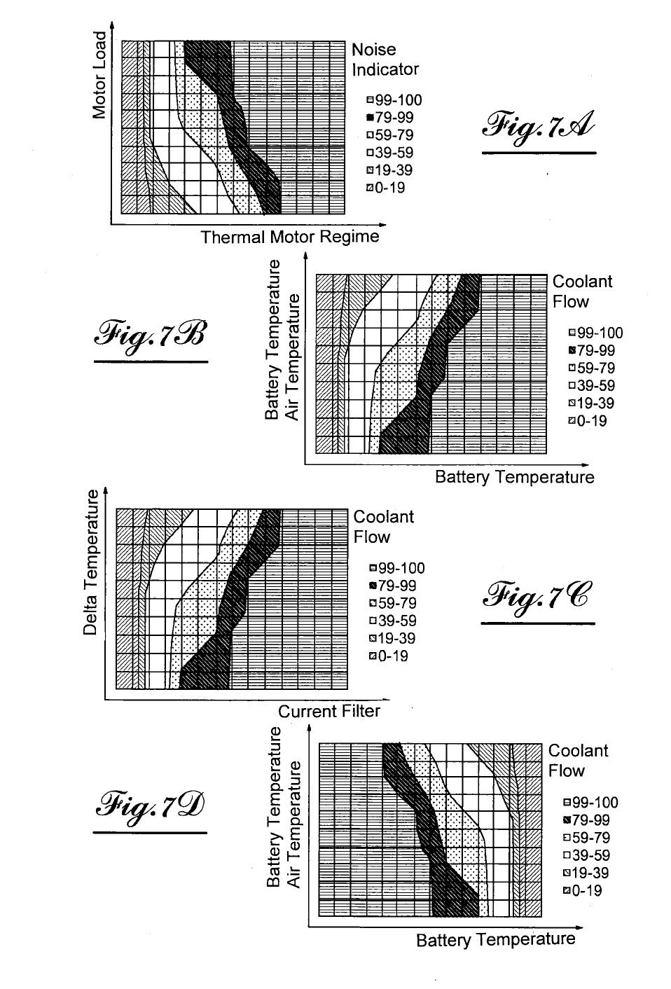

Each of the three intermediate noise levels 25a, 25b and 25c is established according to a characteristic distribution relationship defining the noise level as a function of its characteristic input data. A distribution example of the first intermediate noise level 25a is illustrated in FIG. 7a.

The noise level 25 obtained in this first step 100 is used, subsequently, in the different steps of the control method 100 of the thermoregulation device as input information allowing said method of the rendering of noise generated by the thermoregulation device as much as possible to be imperceptible relative to the ambient noise level.

FIG. 3 provides a functional diagram illustrating the second step 120 of the method 100 for controlling the thermoregulation device for the power supply battery of the vehicle with electrical traction according to the invention.

The second step 120 determines a first calorific flow rate 20a as a function of the temperature 13 of the battery and the temperature 11 of the calorific flow entering the battery and ensuring the cooling of the battery during charge or discharge cycles of the battery that causes it to heat up.

To this end, the second step 120 comprises a first phase 121 in which the noise level 25 determined during the first step 110 is converted to a maximum admissible calorific flow rate, which is used as input information during a second phase 122 in which the calorific flow rate 20a is determined as a function of the temperature 13 of the power supply battery and the temperature 13 of the calorific flow 11 entering the battery.

The conversion of the noise level 25 to a maximum admissible calorific flow rate occurs by means of a one-dimensional reference table.

The calorific flow rate 20a determined during the second stage 120 corresponds with the flow rate necessary for cooling of the power supply battery as a function of the temperature 13 of the battery and the difference between the temperature 13 of the battery and the temperature 11 of the calorific flow entering the battery.

It should be noted that when the gap between the temperature 13 of the power supply battery and the temperature 11 of the calorific flow entering the battery is high, the cooling of the battery by the heat transfer fluid is more effective, which will result in a rather low calorific flow. In this way, the temperature 11 of the calorific flow entering the battery determines the cooling capacity of the thermoregulation device.

The calorific flow rate 20a of the heat transfer fluid is determined by a two dimensional distribution illustrated in FIG. 7b and is limited by the admissible calorific flow rate corresponding to the maximum admissible noise level 25, with the condition that the heating of the battery does not risk degradation of its performance or damage to its durability.

The control method 100 takes into account the limitation of the calorific flow rate during the determination of the calorific flow rate 20a in the second phase 122 according to the following operating logic:
as long as the temperature 13 of the battery is lower than a first threshold value established by the manufacturer, the limitation of the flow rate, determined during the first phase 121, is completely activated in favor of the acoustical comfort in the cabin of the vehicle. The calorific flow rate 20a is then limited by the admissible calorific flow determined during the first phase 121;
when the temperature 13 of the battery is higher than a second threshold value established by the manufacturer, the limitation of the calorific flow, determined during the first phase 121, is no longer taken into account in order to maintain sufficient cooling of the battery so that the performance of the battery is not degraded. In this case, the calorific flow rate 20a is no longer limited by the admissible calorific flow, to the detriment of the acoustic comfort;
when the temperature 13 of the battery is higher than the first threshold value and lower than the second threshold value, the acoustic limitation is taken into account according to a linear relationship. According to one implementation mode of the invention, the calorific flow rate 20a is determined in this zone according to a linear relationship as a function of the temperature 13 of the battery, wherein the linear relationship is passing through two points of which the coordinates represent each of the two previously detailed cases, namely a first point of which the coordinates are the value of the first threshold (admissible flow rate) and a second point of which the coordinates are the value of second threshold (non-limited flow rate).

In this way the control method 100, by way of step 120 favors maintaining the acoustic requirements in practical cases where performance and life of the power supply battery will not be degraded.

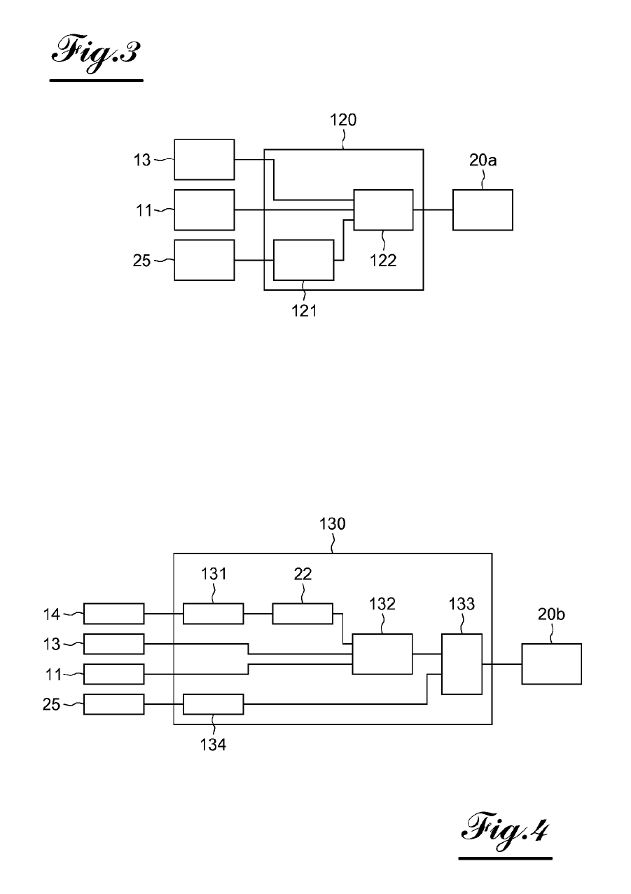

FIG. 4 provides a functional diagram illustrating a third step 130 of the method 100 for controlling the thermoregulation device for the power supply battery of the vehicle with electrical traction according to the invention.

The third step 130 determines a second calorific flow rate 20b as a function of the current passing through the battery 14, the temperature 13 of the battery, and the temperature 11 of the calorific flow entering the battery.

This third step 130 allows for the detection of strong solicitations of the battery, in particular by the current going through the battery, in order to anticipate the heating of the battery and consequently its cooling by increasing the required calorific flow rate 20b.

For this purpose, the third step 130 comprises:
a first phase 134 in which the noise level 25 established during the first step 110 is converted to a maximum admissible calorific flow rate used as input data during the determination of the calorific flow rate 20b;
a second phase 131 in which the intensity of the current 14 passing through the battery is filtered by way of a first order filter, this phase establishes a history of the intensity of the current passing through the power supply battery;
a third phase 132 in which the control method 100 determines the minimum calorific flow rate by way of a distribution law of which an example is illustrated in FIG. 7c and of which the input data is, on the one hand, the intensity of the filtered current 22 and, on the other hand, the temperature difference between the temperature 13 of the battery and the temperature 11 of the calorific flow entering the battery;
a fourth phase 133 in which the calorific flow rate 20b is determined by selecting the lowest flow between the minimum calorific flow rate determined during phase 132 and the maximum admissible calorific flow rate determined during phase 134, corresponding with the admissible noise level limit 25.

The conversion of the noise level 25 into maximum admissible calorific flow rate occurs by way of a one-dimensional reference table that is different from the one-dimensional reference table used during the first step 120.

In a second implementation mode of the invention, the third step 130 which allows the detection of battery overheating risk takes into account, on the one hand, the thermal energy dissipated by Joule effect of the battery and, on the other hand, the thermal energy evacuated by the calorific flow, in order to deduce from it information regarding the cooling needs of the battery, and the ability to anticipate the “heat surge” of the battery.

For this purpose, the third step comprises:
a first phase in which the admissible noise level is converted to an admissible calorific flow rate according to a one-dimensional reference table;
a second phase in which the thermal energy flow going through the battery is determined based on a one-dimensional reference table, this thermal energy flow corresponds with the Joule effect losses caused by a current passing through the battery;
a third phase in which the flow of thermal energy evacuated by the battery is determined starting from the temperature difference between the calorific flow entering the battery and the calorific flow exiting the battery, and the calorific flow rate at a given time;
a fourth phase in which the minimum necessary calorific flow rate for cooling of the battery is determined as a function of the thermal energy stagnating in the battery, obtained by the difference between the thermal energy flow passing through the battery and the thermal energy flow evacuated by the battery, and the temperature difference between the battery temperature and the temperature of the calorific flow entering the battery, wherein the calorific flow rate necessary for cooling is determined by way of a two-dimensional reference table;
a fifth phase in which the calorific flow rate is determined by selecting the lowest flow rate between the calorific flow rates determined during the fourth phase and the maximum admissible calorific flow rate determined during the first phase.

FIG. 5 provides a functional diagram illustrating a fourth step 140 of method 100 for controlling the thermoregulation device for the battery supplying the vehicle with electrical traction according to the invention.

The fourth step 140 allows for cooling of the battery when the powertrain is turned off. Indeed, when the powertrain is turned off, the power supply battery can continue to heat up, consequently causing its degradation if no longer cooled.

Accordingly, the control method 100 takes into account, by way of this fourth step 140, the electrical consumption requirements and acoustical requirements characteristic for this situation while taking into account the cooling efficiency in determining the duration and calorific flow rate 20d to be applied by the thermoregulation device.

For this purpose, the fourth step 140 comprises:
a first phase 141 in which the need is evaluated for cooling of the battery when the powertrain is turned off, by determining, case occurring, a calorific flow rate to be applied and the duration of the flow. These criteria are determined starting from the intensity of the current 14 flowing through the battery which is previously filtered and temperature 23 of the battery measured at the time the powertrain is turned off;
a second phase 142 in which new time and flow criteria are determined of the calorific flow to be applied as a function of the effectiveness of the cooling. Indeed, during this second phase a temperature gradient is determined between the real temperature 13 of the battery and the temperature 23 of the battery measured when the powertrain is turned off;
a third phase 143 the time and flow data of the calorific flow supplied during the first phase 141 and the second phase 142 is coordinated in order to determine a calorific flow rate 20d to be applied. Said third phase 143 receives information about the status of the engine.

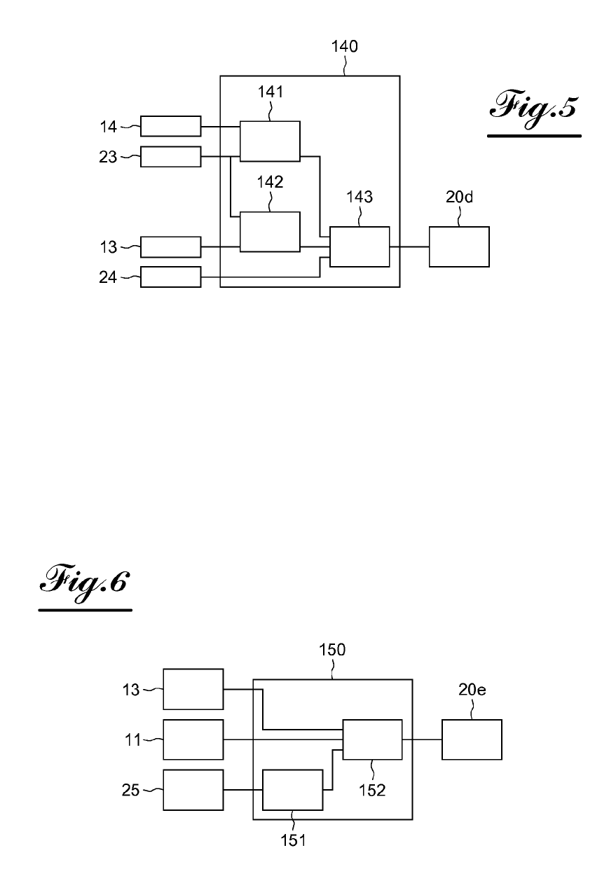

FIG. 6 provides a functional diagram illustrating a fifth step 150 of the method 100 for controlling the thermoregulation device for the power supply battery of the vehicle with electrical traction according to the invention.

The fifth step 150 allows for necessary reheating of the battery when its temperature is low. Indeed, the performance of an electrical power supply battery is reduced when its temperature is too low.

For this purpose, the fifth step 150 comprises;
a first phase 151 in which the noise level 25 determined during the first step 110 is converted to a maximum admissible calorific flow rate used as input data during the determination of the calorific flow rate 20e;
a second phase 152 in which the flow rate of the reheating calorific flow 20e is determined as a function of the temperature of the battery 13 and the difference between the temperature 13 of the battery and the temperature 11 of the calorific flow entering the battery.

In the first phase 151, the conversion of noise level 25 in a maximum admissible calorific flow rate occurs by way of a one-dimensional reference table, different than the reference table used during the first step 120 and the second step 130.

In the second phase 152 the determination of the calorific flow rate 20e occurs by way of a two-dimensional distribution illustrated in FIG. 7d and is limited by the admissible calorific flow rate corresponding with the maximum admissible noise level 25 in order to limit the acoustic hinder in the cabin of the vehicle.

FIG. 7a provides an exemplary graphical illustration of an example of a distribution of the first intermediate noise 25a level determined by the control method 100 as a function of the load of the combustion engine 19 and the speed of the combustion engine 17.

Each load condition 19 and speed condition 17 of the engine corresponds with one noise level.

All of the combinations of engine load 19/engine speed 17 are represented in the graph of FIG. 7a by a noise level 25a. For proper representation, the noise levels 25a are distributed according to 6 ranges: 0-19; 19-39; 39-59; 59-79; 79-99; 99-100, where 0 indicates an extremely low noise level and 100 a high noise level.

It should be noted that the distribution of the noise level 25a with smaller representation ranges, for instance from 1 to 5, would allow for more accurate definition of the graph and the values of noise level 25a for each engine load and engine speed situation.

Each intermediate noise level 25b and 25c is determined according to a distribution similar to the distribution illustrated in FIG. 7a, with only one dimension instead of two.

FIGS. 7b, 7c and 7d provide graphical examples of distributions of the calorific flow rate, respectively 20a, 20b and 20e.

For proper representation, the calorific flow rates 20a, 20b and 20e are distributed according to 6 ranges with values corresponding to a percentage of the maximum flow rate: 1-19%, 19-39%; 39-59%; 59-79%; 70-99%; 99-100%.

It should be noted that the flow rate distributions 20a, 20b and 20e with smaller ranges, for instance from 1 to 5%, would allow for more accurate definition of the graph and the values of the flow rates 20a, 20b and 20e for each situation.

FIG. 7b provides an exemplary illustration of a distribution of the calorific flow rate 20a determined by the control method 100, during the second step 120, as a function of the temperature 13 of the battery and the difference between the temperature 13 of the battery and the temperature of the calorific flow 11 entering the battery.

FIG. 7c provides an exemplary illustration of a distribution of the calorific flow rate 20b determined by the control method 100, during the third step 130, as a function of the intensity of the filtered current 22 and the difference in temperature between the temperature 13 of the battery and the temperature 11 of the calorific flow entering the battery.

FIG. 7d provides an exemplary illustration of a distribution of the calorific flow rate 20e determined by the control method 100, during the fifth step 150, as a function of the temperature of the battery 13 and the difference between the temperature 13 of the battery and the temperature 11 of the calorific flow entering the battery.

In this way, the control method 100, provides an active management of the cooling of the power supply battery of a vehicle with electrical traction without degradation of the noise level in the cabin.

According to different temperature parameters such as the battery temperature and the temperature of the calorific flow and the determination of the noise level present in the cabin, the control method 100 provides by means of the thermoregulation device, a calorific flow rate adapted to each situation while favoring the acoustical comfort of the passengers and by adapting the calorific flow to the correct need and anticipating heavy stresses.

Other specific advantages are the following:
active cooling management reduces energy consumption;
active cooling management increases battery life;
active cooling management provides the necessary cooling when the vehicle runs or is at standstill;
anticipation of heavy current solicitations in order to preserve the availability and life of the batteries;
preferred exploitation of the battery during difficult climatic conditions.

1.-7. (canceled)

8. A method for controlling a thermoregulation device for a power supply battery of a vehicle with electrical traction, cooled by a heat exchange fluid circulated by a circulation flow of said heat transfer fluid and commanded by said thermoregulation device, said control method comprising:
continuously acquiring a temperature of a heat exchange fluid entering a power supply battery of a vehicle, a temperature of the power supply battery, an intensity of a current passing through the power supply battery, a speed of the vehicle, an engine speed of an engine of the vehicle, a speed of the air conditioning blower of the vehicle, and a load on the engine;
establishing, at a first step, a cabin noise level within a cabin of the vehicle, the noise level determined as a function of at least one of the load on the engine, the engine speed, the speed of the air conditioning blower, and the vehicle speed;
establishing, at a second step, a circulation flow rate of the heat exchange fluid to be applied as a function of the temperature of the power supply battery when a powertrain of the vehicle is turned on, the temperature of the heat transfer fluid entering the battery and the noise level in the cabin determined during the first step

9. The method of claim 8, wherein the first step of establishing the cabin noise level comprises:
a first step of detecting a first noise level as a function of the load of the engine and the engine speed;
a second step of detecting a second noise level as a function of the speed of the air conditioning blower;
a third step of detecting a third noise level as a function of the vehicle speed; and
determining the cabin noise level to be the maximum value of the first, second and third noise levels.

10. The method of claim 9 further comprising determining a calorific flow rate as a function of the current intensity going through said battery, the temperature of the battery and the temperature of the heat transfer fluid entering the power supply battery.

11. The method of claim 10, wherein determining the calorific flow rate is additionally a function of a thermal energy flow traversing the battery and a thermal energy flow evacuated by the battery by the heat transfer fluid.

12. The method of claim 10 further comprising determining a cooling flow rate of the heat transfer fluid for cooling of the power supply battery when the powertrain of the vehicle is turned off, said determining of said cooling flow rate comprising:
evaluating, at a first stage, the cooling needs of the battery in which a first flow rate is determined of the heat transfer fluid as a function of the current intensity going through the battery and temperature of the battery at the time the powertrain is turned off;
determining, at a second stage, a second flow rate as a function of the temperature gradient between the temperature of the battery at the time the powertrain is turned off, and the temperature of the battery when the powertrain is turned on;
coordinating, at a third stage, the different data of the first stage and of the second stage, in which the cooling flow rate is determined of the heat transfer fluid for cooling of the battery.

13. The method of claim 12 further comprising determining, at a reheating stage of the power supply battery, a reheating flow rate of the heat transfer fluid as function of the temperature of the battery and the temperature of the heat transfer fluid entering said battery when the powertrain is turned on.

14. The method of claim 13 wherein a maximum circulation flow rate of the heat transfer fluid, as controlled by the thermoregulation device, is increased as the cabin noise level in the cabin of the vehicle increase.
